(19) United States
(12) Patent Application Publication
(10) Pub. No.: US 2012/0254124 A1
(43) Pub. Date: Oct. 4, 2012

(54) SYSTEM, METHOD, AND COMPUTER PROGRAM PRODUCT FOR DISASTER RECOVERY USING ASYNCHRONOUS MIRRORING

(75) Inventors: Lisa J. Gundy, Tucson, AZ (US); Beth A. Peterson, Tucson, AZ (US); Alfred E. Sanchez, Tucson, AZ (US); David M. Shackelford, Tucson, AZ (US); Warren K. Stanley, Loveland, CO (US); John G. Thompson, Tucson, AZ (US)

(73) Assignee: INTERNATIONAL BUSINESS MACHINES CORPORATION, Armonk, NY (US)

(21) Appl. No.: 13/076,024

(22) Filed: Mar. 30, 2011

(51) Int. Cl. G06F 17/30

(52) U.S. Cl. 707/659; 707/E17.007

(57) ABSTRACT

In one embodiment, a computer program product for handling a point-in-time copy (PITC) command includes a computer readable storage medium having computer readable program code embodied therewith. The computer readable program code is configured to: receive a PITC command at a local site, create a data representation that represents updates to make to the at least one target volume of the local target storage location, wherein the updates correspond to changes made to at least one source volume of the local source storage location since execution of an earlier PITC command, create a source data sidefile entry for the at least one source volume, create a target data sidefile entry for the at least one target volume, execute the PITC command at the local site, and create a PITC sidefile entry for the PITC command, the PITC sidefile entry including a timestamp that indicates when the PITC command was executed.

### BACKGROUND

The present invention relates to disaster recovery storage solutions, and more particularly, to asynchronous mirroring for disaster recovery.

In conventional disaster recovery storage systems, data is written to a local system (primary production location) in real-time so that it can be used, and at some later time, preferably in as short a time as is feasible given the system constraints, the data is transferred from the local system to a remote system (disaster recovery location). However, data that is written to the remote system is written in the same order as at the local system, thereby ensuring that changes are properly reflected in the remote system as they are made in the local system.

This is because if data is written out of order on the remote system, and a disaster occurs which renders the data on the local system unusable, the data at the remote system must be consistent with the (now lost) data on the local system. In order to prevent inconsistency between the local system and the remote system, data must be written in the same order to both systems. For example, if four transactions (T1, T2, T3, and T4) take place on a piece of data on the local system, and the transactions are written to the corresponding data on the remote system as T1, T2, T4, and T3, then an attempt to recover the data from the remote system would render data that is inconsistent with what exists on the local system. Similarly, if one of the transactions is missed, e.g., only T1, T2, and T4 are stored to the corresponding data on the remote system, an attempt to recover the data from the remote system would render data that is inconsistent with what exists on the local system.

Generally, a point-in-time copy (PITC) is used to create a backup within a single system, e.g., a group of datasets are copied to a different location, but possibly within the same storage controller.

In actually, since a physical copy takes a tangible amount of time to perform, the backup is typically created with pointers, so that when a request is received to access data from the backup, in some instances, a pointer may point back to the data on the original location. However, this backup still functions as if all of the data was copied instantaneously. These pointers are used for several reasons, including the data being pointed to currently being used, updates being performed on the data which would have to be halted, because the physical copying generally takes a long time to perform, etc. Then, as the resources are available, in some instances, a physical copy may be performed for all of the data, but this is not always done.

For these reasons, a PITC is not useful for disaster recovery, because in some instances, it does not actually have physical copies of the data, and because it may be stored to the same system as the original data, and a disaster would effectively render both copies of the data unusable.

### BRIEF SUMMARY

According to one embodiment, a computer program product for handling a point-in-time copy (PITC) command includes a computer readable storage medium having computer readable program code embodied therewith. The computer readable program code is configured to: receive a PITC command at a local site, the PITC command being for updating data on a local target storage location such that it represents data on a local source storage location; create a data representation that represents updates to be made to the at least one target volume of the local target storage location, wherein the updates correspond to changes made to at least one source volume of the local source storage location since execution of an earlier PITC command; create a source data sidefile entry for the at least one source volume; create a target data sidefile entry for the at least one target volume; execute the PITC command at the local site; and create a PITC sidefile entry for the PITC command, the PITC sidefile entry including a timestamp that indicates when the PITC command was executed.

According to another embodiment, a method for handling a point-in-time copy (PITC) command includes receiving a PITC command at a local site, the PITC command being for updating data on a local target storage location such that it represents data on a local source storage location; creating a PITC sidefile entry for the PITC command, the PITC sidefile entry including a timestamp that indicates when the PITC command was executed; creating a data representation that represents updates to be made to the at least one target volume of the local target storage location, wherein the updates correspond to changes made to at least one source volume of the local source storage location since execution of an earlier PITC command; creating a source data sidefile entry for the at least one source volume; creating a target data sidefile entry for the at least one target volume; and executing the PITC command at the local site.

In another embodiment, a system for storing disaster recovery data includes logic adapted forgathering source sidefile entries from one or more source sidefiles at a local site, wherein the one or more source sidefiles correspond to one or more local source storage locations; logic adapted for detecting a point-in-time copy (PITC) command entry in one of the source sidefiles; logic adapted for sorting the gathered source sidefile entries chronologically by timestamp, wherein source sidefile entries having an earlier timestamp are arranged prior to source sidefile entries having a later timestamp; logic adapted for forming a first consistency group (CG) based on sidefile entries that have a timestamp prior to a timestamp of the PITC command entry; logic adapted for forming a second CG based on the PITC command entry; logic adapted for applying the first CG to one or more remote source storage locations at a remote site, wherein the one or more remote source storage locations correspond to the one or more local source storage locations; and logic adapted for applying the second CG to one or more remote target storage locations at the remote site after applying the first CG, wherein the one or more remote target storage locations correspond to the one or more local target storage locations.

In yet another embodiment, a method for storing disaster recovery data includes gathering source sidefile entries from one or more source sidefiles at a local site, wherein the one or more source sidefiles correspond to one or more local source storage locations; detecting a point-in-time copy (PITC) command entry in one of the source sidefiles; sorting the gathered source sidefile entries chronologically by timestamp, wherein source sidefile entries having an earlier timestamp are arranged prior to source sidefile entries having a later timestamp; forming a first consistency group (CG) based on sidefile entries that have a timestamp prior to a timestamp of the PITC command entry; forming a second CG based on the PITC command entry; applying the first CG to one or more remote source storage locations at a remote site, wherein the one or more remote source storage locations correspond to the one or more local source storage locations; and applying the second CG to one or more remote target storage locations at the remote site after applying the first CG, wherein the one or more remote target storage locations correspond to the one or more local target storage locations.

Other aspects and embodiments of the present invention will become apparent from the following detailed description, which, when taken in conjunction with the drawings, illustrates by way of example the principles of the invention.

### BRIEF DESCRIPTION OF THE SEVERAL VIEWS OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a simplified schematic diagram of a system, according to one embodiment.

FIG. 4 shows a simplified schematic diagram of a system, according to one embodiment.

FIG. 5 is a flow diagram of a method for handling a point-in-time copy command, according to one embodiment.

FIG. 6 is a flow diagram of a method for storing disaster recovery data, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an,” and “the” include plural referents unless otherwise specified.

According to one embodiment, a point-in-time copy (PITC), such as an IBM FlashCopy command, may be used to mirror write data from sidefiles in a local system to sidefiles in a remote system. This results in the remote system having consistent copies of the data on the local system.

As will be appreciated by one skilled in the art, aspects of the present invention may be embodied as a system, method and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as “logic”, a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), a digital versatile disc read-only memory (DVD-ROM), a Blu-ray disc read-only memory (BD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a wide area network (WAN), a storage area network (SAN), etc., or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

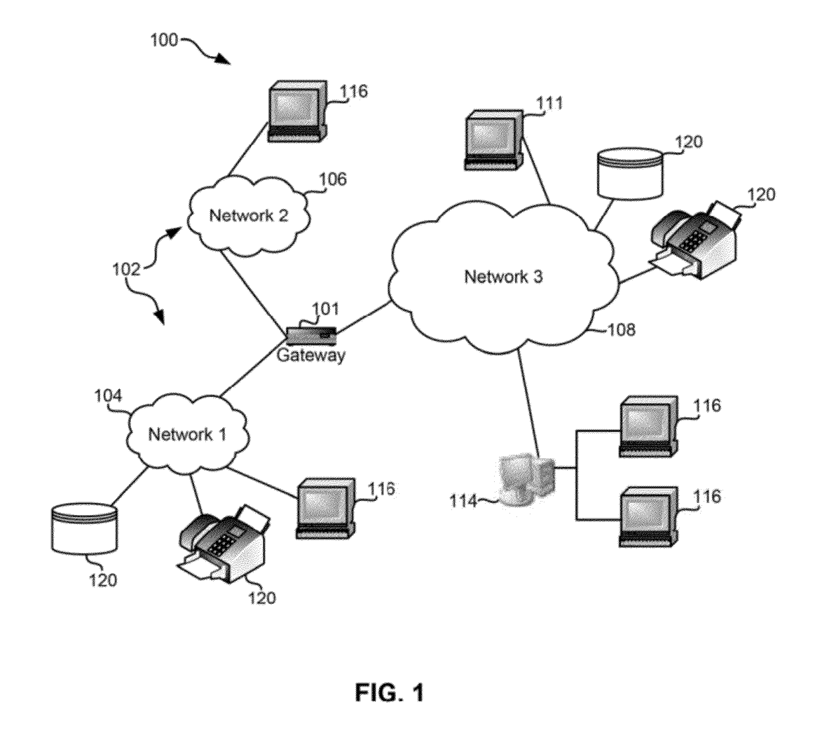

FIG. 1 illustrates a network architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, a SAN, a PSTN, internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network. In one embodiment, peripheral 120 may be an IBM Scaled Out Network Attached Storage (SoNAS). In another embodiment, peripheral 120 may be an IBM System Storage TS7650 ProtecTIER Deduplication Appliance. In yet another embodiment, peripheral 120 may be an IBM System Storage TS3500 Tape Library.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

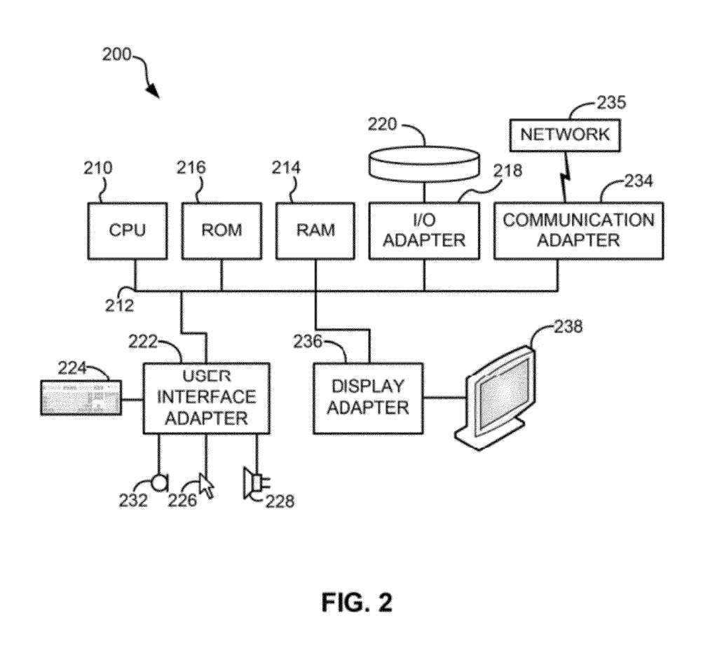

FIG. 2 shows a representative hardware environment 200 associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238. In various embodiments, communication adapter 234 may be chosen from any of the following types: Ethernet, Gigabit Ethernet, Fibre Channel (FC), Fibre Channel over Ethernet (FCoE), Small Computer System Interface (SCSI), Internet Small Computer System Interface (iSCSI), and the like.

The workstation may have resident thereon an operating system such as the MICROSOFT WINDOWS Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

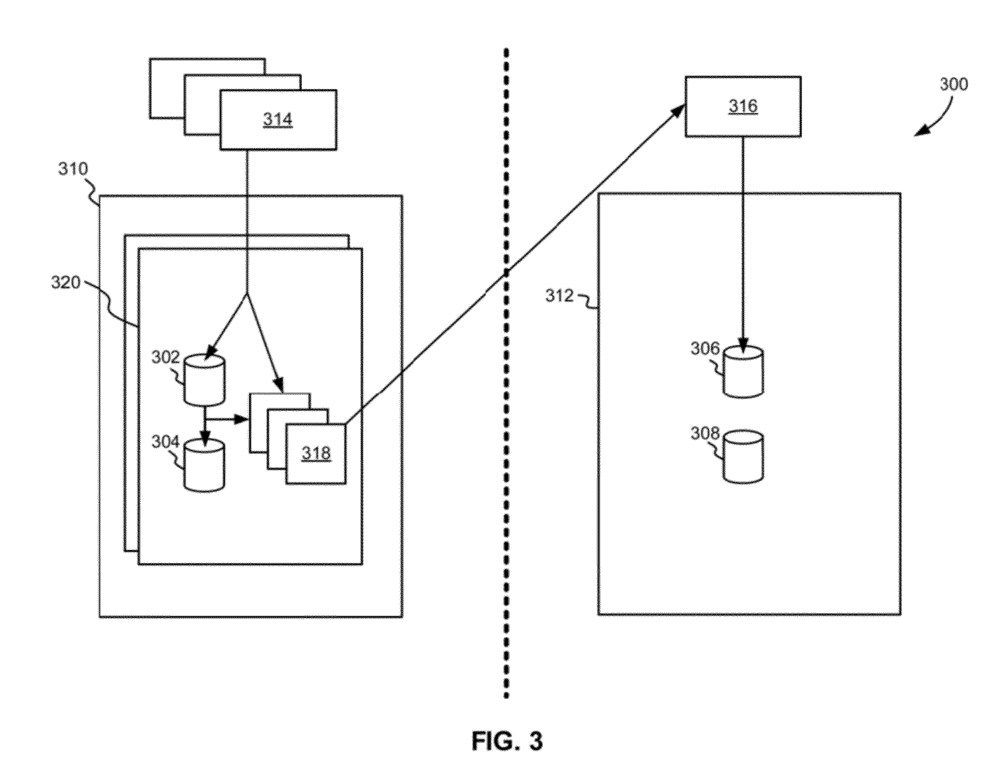

Now referring to FIG. 3, a system 300 is shown according to one embodiment. This shows a general schematic view of a system 300, which may use any operating system (OS), such as IBM z/OS, MICROSOFT WINDOWS, UNIX OS, MAC OS X, etc. A local site 310 includes local storage locations 302 and 304 that may include any computer readable storage media, such as a hard disk drive (HDD), a random access memory (RAM), a read-only memory (ROM), an erasable programmable read-only memory (EPROM or Flash memory), etc., or any other computer readable storage media as known in the art. Local storage locations 302 and 304 may be primary volumes, such as IBM z/GM primary volumes in one embodiment, that may be asynchronously mirrored to remote storage locations 306 and 308, which may be secondary volumes in one embodiment, at a remote site 312. The storage elements 302, 304, 306, and 308 are referred to as storage locations because they can be any type or portion of storage space, such as a track, a volume, an entire medium, a system's storage medium, or any other portion or subportion of storage space as would be understood by one of skill in the art upon reading the present descriptions.

One or more host systems 314 read and/or write data, possibly using a local storage controller 320, which is adapted for controlling read/write operations to a plurality of storage locations, such as local storage locations 302 and 304, at the local site 310, in one approach. A data mover module 316, such as IBM z/GM System Data Mover (SDM) software, which may be executed on the system 3000S, or any host 3140S, such as an IBM z/OS host, may be located at the remote site 312, but may be located at any location, such as a host site, the local site 310, etc.

Data that is written to the local storage locations 302 and 304 is buffered within the local storage controller 320 in a memory structure called a sidefile 318. Each sidefile 318 includes sidefile entries that include a timestamp indicating the time when the data was written. There may be many sidefiles 318 within each storage controller 320, and there may also be multiple storage controllers 320 included in a single data mover module 316 session.

Each local storage location 302, 304 is associated with one or more sidefile 318 buffers. Asynchronous to the data writes to the local storage locations 302, 304, the data mover module 316 reads the buffered data from all the storage controller sidefiles 318. The data mover module 316 orders the data from all of the various sidefiles 318 and creates a Consistency Group (CG). The CG includes all data which was written to the primary storage media 302, 304 between two specific points in time. When all the data for the CG is collected, it is written to the remote storage locations 306, 308 at the remote site 312. In this way, the remote storage locations 306, 308 at the remote site 312 are mirrors of the local storage locations 302, 304 at the local site 310, although due to the asynchronous nature, the data may be written to the remote site 312 at a later time than it was written at the local site 310.

When a point-in-time copy (PITC), such as an IBM FlashCopy, is performed at the local site 310, as show in FIG. 3, a PITC causes a logical copy of data from a source location (such as a source volume on local storage location 302 at the local site 310) to a target location (such as a target volume on remote storage location 304 at the local site 310). This may be seen as logically and instantaneously writing data to the target volume on local storage location 304. Allowing such a copy between local storage locations 302 and 304 causes the remote storage location 308 at the remote site 312 to no longer be a mirror of the data from its corresponding local storage location 304 because the target volume on local storage location 304 has now been logically updated with data from the source volume on local storage location 302.

Accordingly, a method that allows such a PITC command to be mirrored to the remote storage locations 306, 308 at the remote site 312, where the remote storage location 308 remains a mirror of the local storage location 302 at the local site 310. Note that a PITC is typically performed between a source data location and a target data location. For simplicity, this is shown as a copy between two local storage locations 302 and 304. However, as described above, it may be between volumes on the two local storage locations 302 and 304, and/or the source and target data may be a portion of a volume, a portion of a storage medium, and furthermore, it is possible for the source and target locations to reside on the same volume and/or medium.

According to one embodiment, a PITC is often used for a backup within a single system 300, within a single storage controller 320, etc., so a group of datasets are copied to a different location. A PITC takes less time to perform than a physical copy of the group of datasets, and typically while a copy (either physical or PITC) is taking place, any application using data from the group of datasets cannot access the source, so it becomes critical to perform the copy as quickly as possible because the longer the copy takes to happen, the more time is lost where applications cannot perform their assigned tasks. Some users of disaster recovery systems will not tolerate more than a few seconds where applications do not have access to the data. This is a factor in using PITC instead of a more conventional physical copy of data.

In conventional systems, however, that also utilize a disaster recovery solution, such as remote storage locations 306 and 308 in FIG. 3, a PITC is unable to copy data onto a volume that is also part of the remote disaster recovery solution.

Basically, the problem is that if a PITC is made of local storage location 302 to local storage location 304, it is only a logical copy from local storage location 302 to local storage location 304, and there is no mechanism for the same operation to occur between the remote storage location 306 and the remote storage location 308. Therefore, when a PITC is performed at the local site 310, it's as if the data is physically written to the remote storage location 308. The remote site 312 that has that data has only a few options, including 1) physically copy that data all the way over from local storage location 304 to remote storage location 308, which takes a long time, or, instead of transferring the data from local storage location 304 to remote storage location 308, transfer the PITC command itself. Then, at the remote site 312, at an appropriate time, the same operation that occurred on the local storage location 304 may be performed at the remote site 312.

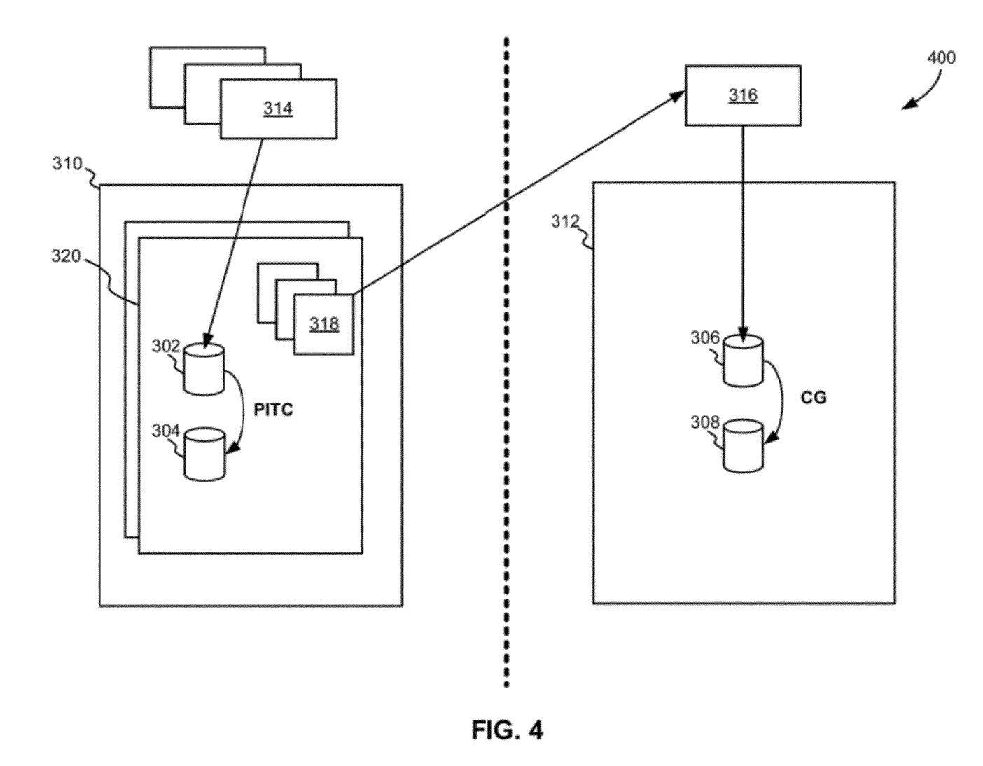

Now referring to FIG. 4, a system 400 is shown according to one embodiment. In this system 400, all the PITC updates are read from the local site 310, and the system 400 periodically forms a CG at the remote site 312. At numerous points in time, such as once a second, once a minute, once every ten seconds, etc., the system 400 collects all the data, and makes a CG so that the copy has all the data created up to that point in time. Then, the system 400 collects all the data created in the next time interval, and forms that data into a CG. In this way, the system 400 is continuously forming discrete points in time at the remote site 312 which can be updated to reflect changes at the local site 310.

According to one embodiment, the system 400 for storing disaster recovery data includes logic. The logic can be of any kind or type, as described earlier. The logic is adapted for: gathering source sidefile entries from one or more source sidefiles 318 at a local site 310, wherein the one or more source sidefiles 318 correspond to one or more local source storage locations 302, detecting a PITC command entry in one of the source sidefiles 318, sorting the gathered source sidefile entries chronologically by timestamp, wherein source sidefile entries having an earlier timestamp are arranged prior to source sidefile entries having a later timestamp, forming a first CG based on sidefile entries that have a timestamp prior to a timestamp of the PITC command entry, forming a second CG based on the PITC command entry, applying the first CG to one or more remote source storage locations 306 at a remote site 312, wherein the one or more remote source storage locations 306 correspond to the one or more local source storage locations 302 and applying the second CG to one or more remote target storage locations 308 at the remote site 312 after applying the first CG, wherein the one or more remote target storage locations 308 correspond to the one or more local target storage locations 304.

In some embodiments, the first CG may be split into several smaller CGs, each smaller CG being based on chronological portions of the sidefile entries that have a timestamp prior to a timestamp of the PITC command entry, and the smaller CGs may be applied to the one or more remote source storage locations 306 chronologically.

In another embodiment, the first CG may be applied to the one or more remote source storage locations 306 in parallel processes.

When a PITC is made between local storage location 302 and local storage location 304 at the local site 310, the point in time at which the PITC was made is recorded, and the data mover module 316 may form a CG at the remote site 312 at substantially the same time, so all the data that is written at the local site 310 that occurs up until the point in time when the PITC occurs is used to form a CG.

In this PITC methodology, sidefiles 318 are created which act as a first-in, first-out (FIFO) buffer. So when data is written to the local site 310, every piece of data gets buffered in one or more sidefiles 318, and each piece of data that is written has a corresponding entry in the one or more sidefiles 318, which may be, in one embodiment, a portion of processor memory that holds data temporarily. In this way, the data gets buffered in and out of the FIFO buffer sidefiles 318. The data is placed in the one or more sidefiles 318 sequentially. The data mover module 316 continually reads the data out of the one or more sidefiles 318 in the same order that the data was written, and as soon as the data mover module 316 has read the data, the data may be discarded from the one or more sidefiles 318. In short, data changes are buffered into the one or more sidefiles 318, and then is removed from the one or more sidefiles 318 by the data mover module 316.

In embodiments where many sidefiles 318 are being used, a control unit (not shown) may control them and may use many different sidefiles 318 for each volume on the various primary storage media at the local site 310. In one embodiment, the control unit may be a storage controller 320. In addition, there may be multiple control units controlling the sidefiles 318, in more embodiments. Therefore, the data mover module 316 reads all the sidefiles 318, compares timestamps among the sidefiles 318, and everything that is used to form a CG within the sidefiles 318.

When the data mover module 316 removes data from the sidefiles 318, it creates a CG, pushes the CG down to remote storage location 306, and then writes the data just like it would have been written on local storage location 302, so that all of the stored data is consistent. Therefore, the data mover module 316 receives the PITC at substantially the same time as the local site 310, thereby allowing this functionality to occur.

For example, in conventional systems, the sidefile 318 only holds data; however, in embodiments described herein, it is not data that is being transmitted between the local site 310 and the remote site 312, but instead a PITC command is saved to the sidefile 318 and is transmitted to the data mover module 316 to be moved to the remote site 312. The PITC command is packaged up to look like data so it gets transferred to the remote site 312, but when the data mover module 316 receives the PITC command, the data mover module 316 recognizes it not as data, but instead as a PITC command that needs to be performed at the remote site 312.

According to one embodiment, a timestamp is associated with each PITC command, thereby allowing the system 400 to determine which PITC command to perform first, e.g., the PITC command includes at what time the PITC occurred at the local site 310, all the information required to perform the same operation, all the parameters for the PITC command, which volumes and which portions of each volume are affected and are to be copied, etc.

According to another embodiment, where the mirroring is stopped, referred to as a “suspend,” which may occur when communication between the local site 310 and the remote site 312 is lost, or during maintenance of either site, or for any of various other reasons as would be understood by one of skill in the art upon reading the present descriptions. When mirroring is suspended, all the data that is buffered in the sidefiles 318 on the local site 310 is discarded, according to one embodiment. For example, if communication is lost for a period of time (such as 1 minute), processor memory for storing data in the sidefiles 318 would quickly be exhausted, since it is not being removed by the data mover module 316.

In order to resolve this issue, in one embodiment, modifications to a portion of a volume may be stored to the sidefiles 318 upon a loss of communication during a remote mirror operation; accordingly, for each volume at the remote site 312, a bitmap that represents an entire volume is stored. In one embodiment, each track of the volume may be indicated by a bit in the bitmap, with changes to the track being reflected by the bit in the bitmap. Further, when a suspend is encountered, all data in the sidefiles 318 is discarded, and modifications to data is recorded to the sidefiles 318 instead of the actual data itself, thereby prolonging the availability of space in the sidefiles 318. When the remote mirror resumes, the data mover module 316 reads from the sidefiles 318 which tracks on each volume changed during the communication outage. Then, the data mover module 316 reads all the data in each track that has been modified, and writes it to the remote site 312.

When PITC is used to copy data from one volume to another and an interruption in communication occurs, not only has all the data in the sidefile been lost, but all indication of the PITC operations that may have happened during the interruption have also been lost, in conventional techniques. However, using embodiments described herein, this situation can be avoided. For example, if a suspend occurs, and there is a write to volume 1, track 10, when this write is requested, there is an indication that there was a write to volume 1, track 10, and the data mover module 316 is pointed to that track to read the data when mirroring is resumed.

In another example, consider a situation where instead of a write, a PITC from local storage location 302 to local storage location 304 is requested while suspended. Now when mirroring is resumed, the occurrence of the PITC is unknown by the data mover module 316, in conventional techniques. Accordingly, the information that data on local storage location 304 was logically updated by that PITC is needed so that it can be transmitted to the remote site 312. Using embodiments disclosed herein, in the situation just described, the existing bitmap mechanism may be reused. For example, if there is a PITC for local storage location 302 to local storage location 304, volume 1, tracks 1-10, then the bits are turned on (0 to 1 or vice versa) for local storage location 304, volume 1, tracks 1-10, so that when mirroring is resumed, the bitmap indicates that local storage location 304, volume 1, tracks 1-10 were modified. It doesn't really matter how they were modified, because the data mover module 316 using the bitmap knows to read tracks 1-10 and mirror any changes to the remote site 312. Therefore, in the situation described above, the PITC itself is not mirrored, and a physical copy of the data is made.

In another embodiment, modifications to data, such as a PITC, may be made from primary storage medium 302 to primary storage medium 304. However, these changes may not be desired, or they may be temporary in nature, and therefore the changes may be backed out, referred to as a “withdraw,” by removing the PITC relationship that was created by the PITC command, which has the effect of logically backing out the changes made by the PITC command. There are many various reasons why a withdraw may be desired, such as problems that are encountered when updating or modifying either of the primary storage media 302, 304, saving a datapoint on either of the primary storage media 302, 304, installing new applications, programs, etc., on primary storage medium 302 that may or may not operate properly, so the changes are wanted to be reflected on primary storage medium 304 until it can be verified that it was successful, etc. In any of these situations, a sidefile 318 entry is created indicating that a relationship between two storage locations is withdrawn, and a timestamp is created to indicate a point in time at which it occurred. Again, this data is read by the data mover module 316, which creates a CG and performs the same command on remote storage locations 306, 308 at the remote site 312.

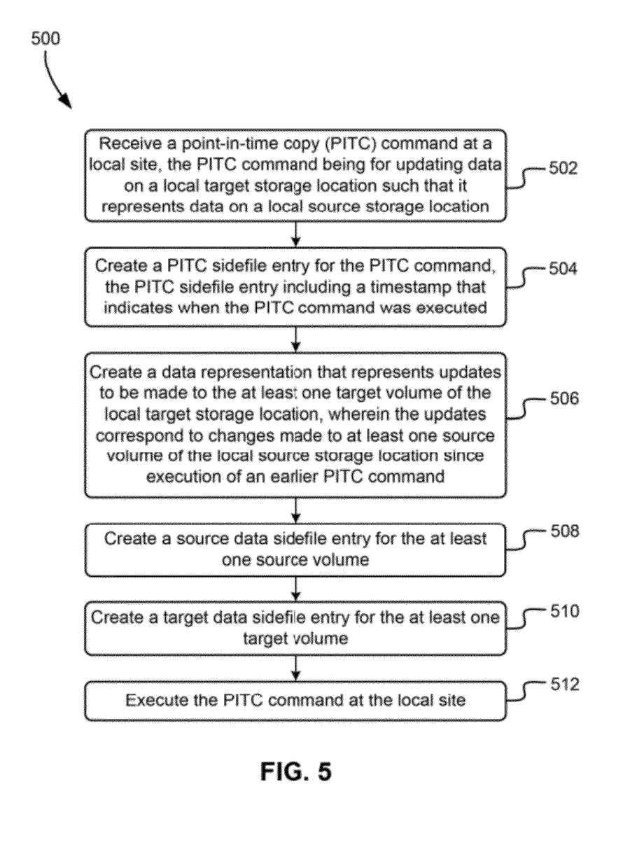

Now referring to FIG. 5, a method 500 for handling a PITC command is shown according to one embodiment. Of course, the method 500 may include more or fewer operations than those described below and shown in FIG. 5, as would be apparent to one of skill in the art upon reading the present descriptions. Also, the method 500 may be performed in any desired environment, and may involve systems, components, etc., as described in FIGS. 1-4, among others.

The method 500 may be carried out on a network using any known protocol, such as Ethernet, Fibre Channel (FC), FC over Ethernet (FCoE), etc., according to some embodiments. In another embodiment, the method 500 may be executed on a host system, a device, a management server, etc., or any other system, server, application, or device as would be apparent to one of skill in the art upon reading the present descriptions.

In another approach, the method 500 may be performed by a computer program product and/or a system using logic and/or modules, etc.

In operation 502, a PITC command is received at a local site. The PITC command, in one embodiment, may be an establish command, indicating that a PITC is to be made of data on at least one source volume of a first local storage medium. According to one embodiment, the PITC command is for updating data on a local target storage location such that it represents data on a local source storage location.

In operation 504, a PITC sidefile entry is created for the PITC command, the PITC sidefile entry including a timestamp that indicates when the PITC command was executed. If the PITC command does not include a timestamp indicating when the PITC command occurred, then a timestamp is appended to the PITC sidefile entry, in some embodiments.

In operation 506, a data representation is created that represents updates to be made to the at least one target volume of the local target storage location, wherein the updates correspond to changes made to at least one source volume of the local source storage location since execution of an earlier PITC command.

In one embodiment, one bitmap for each volume is used to represent updates that were made to a corresponding source volume. For example, a bitmap representing at least one target volume of a second local storage medium may be created that reflects changes that are required to be made during execution of the PITC command, with each bit in the bitmap representing a track in the volume. Of course, other methods of representing changes made be used, and the bitmap is simply one embodiment of such a method.

In one embodiment, bits in the bitmap may be set such that changes that are to be made to the at least one target volume are indicated by the set bits. For example, if tracks are to be copied from the at least one source volume of the first local storage medium to the at least one target volume of the second local storage medium, bits may be set for those tracks on the second local storage medium to indicate that they will be changed by the PITC.

In operation 508, a source data sidefile entry is created for the at least one source volume. The source data sidefile entry may include, according to one embodiment, the PITC command (including all parameters associated with the PITC command), a timestamp indicating when the PITC command was executed, one or more source data locations on the at least one source volume, and one or more target data locations on the at least one target volume that correspond to the one or more source data locations.

In one embodiment, the source data sidefile entry may include data changes that are made to the at least one source volume. In an alternative embodiment, data changes may be stored in a separate sidefile entry from the source data sidefile entry.

In optional operation 510, a target data sidefile entry is created for the at least one target volume. The target data sidefile entry may include, according to one embodiment, the PITC command (including all parameters associated with the PITC command), a timestamp indicating when the PITC command was executed, a timestamp of a current time on the at least one target volume, one or more source data locations on the at least one source volume, and one or more target data locations on the at least one target volume that correspond to the one or more source data locations.

In operation 512, the PITC command is executed at the local site.

In one embodiment, the target data sidefile entry may include data changes that are made to the at least one target volume. In an alternative embodiment, data changes may be stored in a separate sidefile entry from the target data sidefile entry.

In some approaches, the target data sidefile entry may be marked as “in progress,” indicating that it is not complete.

In another embodiment, the source data sidefile entry may be marked as “in progress,” indicating that it is not complete.

In further approaches, each source sidefile entry and target sidefile entry may be marked as “complete,” indicating that the underlying PITC was successfully executed unless the PITC was not successful, in which case each source sidefile entry and target sidefile entry is marked as “invalid,” indicating that the underlying PITC was not successfully completed, and an error indication is sent to an application from which the PITC command was received.

For additional PITC commands or to retry PITC commands that are marked invalid, the method 500 may be repeated as many times as necessary until all sidefile entries are marked “complete.”

In some further embodiments, information for mapping the local source storage location to a remote source storage location may be received, wherein data and data locations on the remote source storage location correspond to data and data locations on the local source storage location.

In more embodiments, information for mapping the local target storage location to a remote target storage location may be received, wherein data and data locations on the remote target storage location correspond to data and data locations on the local target storage location.

According to one embodiment, the local source storage location may be mapped to the corresponding remote source storage location, and the local target storage location may be mapped to the remote target storage location, such as by using the information for mapping described previously.

By using method 500, a data mover module or any other system, logic, module, system, etc., as is known by one of skill in the art, may ensure data consistency by recognizing changes to local storage media and indicating those changes to corresponding remote storage media, in various embodiments.

Of course, any of the above described embodiments may be implemented in a system and/or a computer program product as would be understood by one of skill in the art upon reading the present descriptions.

For example, in one embodiment, a computer program product for handling a point-in-time copy command may include a computer readable storage medium having computer readable program code embodied therewith. The computer readable program code is configured to: receive a PITC command at a local site, the PITC command being for updating data on a local target storage location such that it represents data on a local source storage location, create a data representation that represents updates to be made to the at least one target volume of the local target storage location, wherein the updates correspond to changes made to at least one source volume of the local source storage location since execution of an earlier PITC command, create a source data sidefile entry for the at least one source volume, create a target data sidefile entry for the at least one target volume, execute the PITC command at the local site, and create a PITC sidefile entry for the PITC command, the PITC sidefile entry including a timestamp that indicates when the PITC command was executed.

Of course, any of the other embodiments described previously may be applied in the computer program product, according to various approaches.

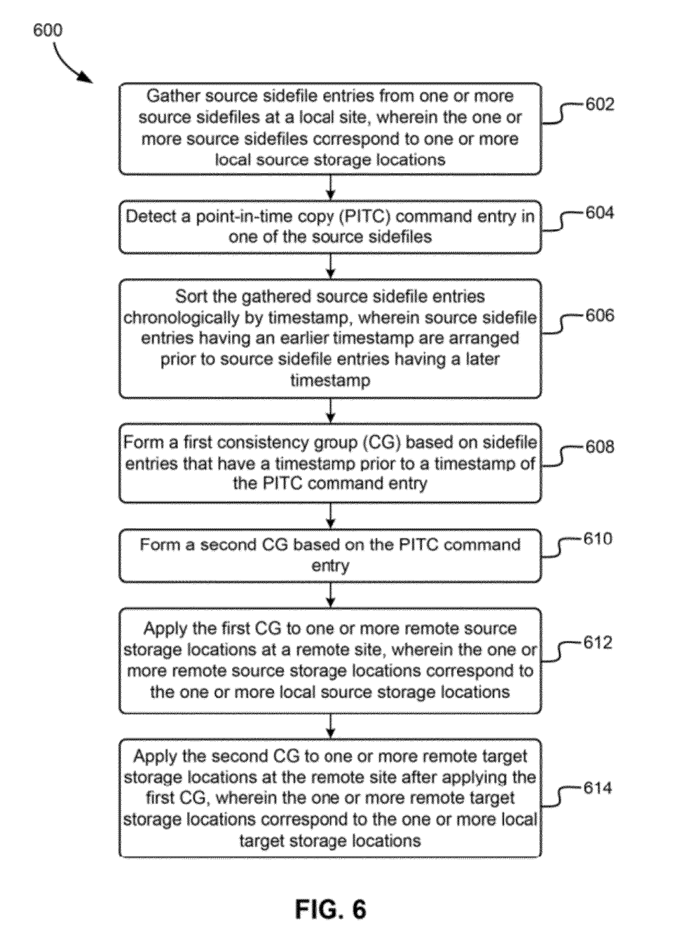

Now referring to FIG. 6, a method 600 for storing disaster recovery data is shown according to one embodiment. Of course, the method 600 may include more or fewer operations than those described below and shown in FIG. 6, as would be apparent to one of skill in the art upon reading the present descriptions. Also, the method 600 may be performed in any desired environment, and may involve systems, components, etc., as described in FIGS. 1-4, among others.

The method 600 may be carried out on a network using any known protocol, such as Ethernet, Fibre Channel (FC), FC over Ethernet (FCoE), etc., according to some embodiments. In another embodiment, the method 600 may be executed on a host system, a device, a management server, etc., or any other system, server, application, or device as would be apparent to one of skill in the art upon reading the present descriptions.

In another approach, the method 600 may be performed by a computer program product and/or a system using logic and/or modules, etc.

In operation 602, source sidefile entries from one or more source sidefiles at a local site are gathered, wherein the one or more source sidefiles correspond to one or more local source storage locations.

In one embodiment, the groups are at least separated by PITC commands from a first local storage location to a second local storage location at the local site, but may be further separated by other logical breaks as would be understood by one of skill in the art upon reading the present descriptions, such as all updates to one volume, all updates to one local storage medium, all updates during a period of time, etc.

In one embodiment, all source storage controllers and source XRC sessions may be used to gather source sidefile entries, e.g., multiple source sidefiles may exist for multiple storage controllers, or other devices, systems, etc.

In operation 604, a PITC command entry in one of the source sidefiles is detected.

In operation 606, the gathered source sidefile entries are sorted chronologically by timestamp, wherein source sidefile entries having an earlier timestamp are arranged prior to source sidefile entries having a later timestamp.

In operation 608, a first CG based on sidefile entries that have a timestamp prior to a timestamp of the PITC command entry is formed.

For example, all updates that occur during a time period may be packaged together into a first CG, and any updates that occur after the end of the time period may be deferred to a next CG.

Once the first CG is formed based on the updates that occurred during the time period, which means that all updates that occurred during the time period are reflected in the first CG, then the first CG may be written to, applied to, used for updating, etc., remote storage location at a remote site. This process may be repeated over and over again for any number of time periods, with each time period including any amount of updates to data on the local site. Therefore, at any point in time, remote storage locations where the CGs are applied may be an amount of updates behind the local storage locations.

In operation 610, a second CG is formed based on the PITC command entry.

In one embodiment, if all sidefile entries are being read from one or more sidefiles at the local site, such as by a data mover module, and being sorted to create one or more CGs, and a PITC command entry is read in one of the sidefiles, then a boundary is created that ends the one or more CGs, since including updates that overlap a PITC into a CG would result in inconsistency in the data. Therefore, any PITC is treated as a boundary, and furthermore, these PITC commands are isolated into their own CG, because a remote storage location that has mirrored data from a local storage location needs to be at the exact same point as the local storage location was when the PITC command occurred at the local site, before the PITC command may be applied to the remote storage location. Since the application of a CG does not guarantee any order in which the updates will be applied, the PITC command is packed into its own CG so that changes before the PITC command and after the PITC command are properly reflected in the mirrored storage locations.

In operation 612, the first CG is applied to one or more remote source storage locations at a remote site. The one or more remote source storage locations correspond to the one or more local source storage locations, e.g., the remote source storage locations may be used to mirror the local source storage locations from which the sidefile entries were created.

When the updates for a CG are being applied to the remote storage locations, in one embodiment, they may be performed in parallel processes for the sake of efficiency, so there is no guarantee of the order in which the updates are written to the remote storage locations. This is not a problem because once the updates are completed, the data is consistent by design. If an error occurs during an update, then the data may be inconsistent, but journal entries may be stored along with each step of the updating process, so the erroneous updates can be backed out again to a partial CG or to a point where the data is once again consistent on the remote and local storage locations.

In another embodiment, as previously described, a target sidefile may have two timestamps, e.g., the current (actual) time on the remote storage location and the time the sidefile entry occurred on the local storage location. It is the current time on the remote storage location that is used to create the CG. The timestamp from the local storage location is available so that the two sidefile entries may be matched up and to ensure that they correspond to one another. For example, a data mover module may read the sidefiles and determine that one is a source entry and that one is a target entry, and then the data mover module may use the one common timestamp to ensure that the two entries correspond to one another.

In operation 614, the second CG is applied to one or more remote target storage locations at the remote site after applying the first CG. The one or more remote target storage locations correspond to the one or more local target storage locations. In this way, the PITC command update is reflected on the remote target storage locations in the same way that it was reflected on the local target storage locations.

The method 600 may be repeated any number of times in order to mirror the updates to the local storage locations to the remote storage locations over any period of time.

According to some approaches, the first CG may be split into several smaller CGs, each smaller CG being based on chronological portions of the sidefile entries that have a timestamp prior to a timestamp of the PITC command entry. The smaller CGs may then be applied to the one or more remote source storage locations chronologically.

In more approaches, the first CG may be applied to the one or more remote source storage locations in parallel processes.

In one embodiment, if the application of the second CG fails on the one or more remote storage locations, e.g., the PITC command is unsuccessful, a session is suspended, and a bitmap that was created on the local site is used to determine at which point the update failed. When the session is resumed, the bitmap is used to determine which portions of the one or more remote storage locations still need to be updated so that the data on the local storage locations and the remote storage locations are consistent.

Of course, any of the above described embodiments may be implemented in a system and/or a computer program product as would be understood by one of skill in the art upon reading the present descriptions.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A computer program product for handling a point-in-time copy command, comprising a computer readable storage medium having computer readable program code embodied therewith, the computer readable program code comprising:
computer readable program code configured to receive a point-in-time copy (PITC) command at a local site, the PITC command being for updating data on a local target storage location such that it represents data on a local source storage location;
computer readable program code configured to create a data representation that represents updates to be made to the at least one target volume of the local target storage location, wherein the updates correspond to changes made to at least one source volume of the local source storage location since execution of an earlier PITC command;
computer readable program code configured to create a source data sidefile entry for the at least one source volume;
computer readable program code configured to create a target data sidefile entry for the at least one target volume;
computer readable program code configured to execute the PITC command at the local site; and
computer readable program code configured to create a PITC sidefile entry for the PITC command, the PITC sidefile entry including a timestamp that indicates when the PITC command was executed.

2. The computer program product as recited in claim 1, wherein the source data sidefile entry comprises:
the PITC command including parameters associated with the PITC command;
a timestamp indicating when the PITC command was executed;
one or more source data locations on the at least one source volume; and
one or more target data locations on the at least one target volume that correspond to the one or more source data locations.

3. The computer program product as recited in claim 1, wherein the target data sidefile entry comprises:
the PITC command including parameters associated with the PITC command;
a timestamp indicating when the PITC command was executed;
a timestamp of a current time on the at least one target volume;
one or more source data locations on the at least one source volume; and
one or more target data locations on the at least one target volume that correspond to the one or more source data locations.

4. The computer program product as recited in claim 1, further comprising computer readable program code configured to mark the target data sidefile entry and the source data sidefile entry as “in progress” prior to executing the PITC command.

5. The computer program product as recited in claim 1, further comprising computer readable program code configured to mark the target data sidefile entry and the source data sidefile entry as “complete” after successfully executing the PITC command.

6. The computer program product as recited in claim 1, wherein the data representation comprises at least one bitmap, wherein one bitmap for each target volume is used to represent updates that were made to a corresponding source volume, wherein each bit in the bitmap represents one track on the target volume.

7. The computer program product as recited in claim 1, further comprising:
computer readable program code configured to receive information for mapping the local source storage location to a remote source storage location, wherein data and data locations on the remote source storage location correspond to data and data locations on the local source storage location;
computer readable program code configured to receive information for mapping the local target storage location to a remote target storage location, wherein data and data locations on the remote target storage location correspond to data and data locations on the local target storage location;
computer readable program code configured to map the local source storage location to the corresponding remote source storage location; and
computer readable program code configured to map the local target storage location to the remote target storage location.

8. A method for handling a point-in-time copy command, the method comprising:
receiving a point-in-time copy (PITC) command at a local site, the PITC command being for updating data on a local target storage location such that it represents data on a local source storage location;
creating a PITC sidefile entry for the PITC command, the PITC sidefile entry including a timestamp that indicates when the PITC command was executed;
creating a data representation that represents updates to be made to the at least one target volume of the local target storage location, wherein the updates correspond to changes made to at least one source volume of the local source storage location since execution of an earlier PITC command;
creating a source data sidefile entry for the at least one source volume;
creating a target data sidefile entry for the at least one target volume; and
executing the PITC command at the local site.

9. The method as recited in claim 8, wherein the source data sidefile entry comprises:
the PITC command including parameters associated with the PITC command;
a timestamp indicating when the PITC command was executed;
one or more source data locations on the at least one source volume; and
one or more target data locations on the at least one target volume that correspond to the one or more source data locations.

10. The method as recited in claim 8, wherein the target data sidefile entry comprises:
the PITC command including parameters associated with the PITC command;
a timestamp indicating when the PITC command was executed;
a timestamp of a current time on the at least one target volume;
one or more source data locations on the at least one source volume; and
one or more target data locations on the at least one target volume that correspond to the one or more source data locations.

11. The method as recited in claim 8, further comprising marking the target data sidefile entry and the source data sidefile entry as “in progress” prior to executing the PITC command.

12. The method as recited in claim 8, further comprising marking the target data sidefile entry and the source data sidefile entry as “complete” after successfully executing the PITC command.

13. The method as recited in claim 8, wherein the data representation comprises at least one bitmap.

14. The method as recited in claim 13, wherein one bitmap for each target volume is used to represent updates that were made to a corresponding source volume, wherein each bit in the bitmap represents one track on the target volume.

15. The method as recited in claim 8, further comprising:
receiving information for mapping the local source storage location to a remote source storage location, wherein data and data locations on the remote source storage location correspond to data and data locations on the local source storage location; and
receiving information for mapping the local target storage location to a remote target storage location, wherein data and data locations on the remote target storage location correspond to data and data locations on the local target storage location.

16. The method as recited in claim 15, further comprising:
mapping the local source storage location to the corresponding remote source storage location; and
mapping the local target storage location to the remote target storage location.

17. A system for storing disaster recovery data, the system comprising:
logic adapted for gathering source sidefile entries from one or more source sidefiles at a local site, wherein the one or more source sidefiles correspond to one or more local source storage locations;
logic adapted for detecting a point-in-time copy (PITC) command entry in one of the source sidefiles;
logic adapted for sorting the gathered source sidefile entries chronologically by timestamp, wherein source sidefile entries having an earlier timestamp are arranged prior to source sidefile entries having a later timestamp;
logic adapted for forming a first consistency group (CG) based on sidefile entries that have a timestamp prior to a timestamp of the PITC command entry;
logic adapted for forming a second CG based on the PITC command entry;
logic adapted for applying the first CG to one or more remote source storage locations at a remote site, wherein the one or more remote source storage locations correspond to the one or more local source storage locations; and
logic adapted for applying the second CG to one or more remote target storage locations at the remote site after applying the first CG, wherein the one or more remote target storage locations correspond to the one or more local target storage locations.

18. The system as recited in claim 17, wherein the first CG is split into several smaller CGs, each smaller CG being based on chronological portions of the sidefile entries that have a timestamp prior to a timestamp of the PITC command entry, and wherein the smaller CGs are applied to the one or more remote source storage locations chronologically.

19. The system as recited in claim 17, wherein the first CG is applied to the one or more remote source storage locations in parallel processes.

20. A method for storing disaster recovery data, the method comprising:
gathering source sidefile entries from one or more source sidefiles at a local site, wherein the one or more source sidefiles correspond to one or more local source storage locations;
detecting a point-in-time copy (PITC) command entry in one of the source sidefiles;
sorting the gathered source sidefile entries chronologically by timestamp, wherein source sidefile entries having an earlier timestamp are arranged prior to source sidefile entries having a later timestamp;
forming a first consistency group (CG) based on sidefile entries that have a timestamp prior to a timestamp of the PITC command entry;
forming a second CG based on the PITC command entry;
applying the first CG to one or more remote source storage locations at a remote site, wherein the one or more remote source storage locations correspond to the one or more local source storage locations; and
applying the second CG to one or more remote target storage locations at the remote site after applying the first CG, wherein the one or more remote target storage locations correspond to the one or more local target storage locations.

21. The method as recited in claim 20, wherein the first CG is split into several smaller CGs, each smaller CG being based on chronological portions of the sidefile entries that have a timestamp prior to a timestamp of the PITC command entry, and wherein the smaller CGs are applied to the one or more remote source storage locations chronologically.

22. The method as recited in claim 20, wherein the first CG is applied to the one or more remote source storage locations in parallel processes.
